(19) United States
(12) Patent Application Publication
(10) Pub. No.: US 2025/0005324 A1
(43) Pub. Date: Jan. 2, 2025

(54) BILEVEL DECENTRALIZED MULTI-AGENT LEARNING

(71) Applicants: International Business Machines Corporation, Armonk, NY (US); Regents of the University of Minnesota, Minneapolis, MN (US)

(72) Inventors: Siliang Zeng, Minneapolis, MN (US); Songtao Lu, White Plains, NY (US); Xiaodong Cui, Chappaqua, NY (US); Mark S. Squillante, Greenwich, CT (US); Lior Horesh, North Salem, NY (US); Brian E. D. Kingsbury, Cortlandt Manor, NY (US); Mingyi Hong, Wayzata, MN (US)

(21) Appl. No.: 18/217,081

(22) Filed: Jun. 30, 2023

(51) Int. Cl. G06N 3/045

(52) U.S. Cl. CPC G06N 3/045

(57) ABSTRACT

A computer-implemented method of decentralized multi-agent learning for use in a system having a plurality of intelligent agents each having a personal portion and a shared portion, is provided. The method includes iteratively, until each of a personal goal and a network goal are optimized: determining a feedback associated with an action relative to a personal goal and a degree of similarity relative to a shared goal; adjusting a policy based on the feedback to gain a superior feedback from a next action; broadcasting the shared policy; receiving the at least one of the one or more other intelligent agents' shared policy; generating a combined policy by combining the personal policy and the at least one of the one or more other intelligent agents' shared policy; estimating, using the combined policy, a network value function; and conducting the next action in accordance with the combined policy.

### JOINT RESEARCH AGREEMENT

This invention was made pursuant to a joint study agreement between International Business Machines, Inc. and University of Minnesota.

### STATEMENT REGARDING PRIOR DISCLOSURES BY THE INVENTOR OR A JOINT INVENTOR

The following disclosure(s) are submitted under 35 U.S.C. 102 (b) (1) (A):

### DISCLOSURE(S)

Songtao Lu, Siliang Zeng, Xiaodong Cui, Mark S. Squillante, Lior Horesh, Brian Kingsbury, Jia Liu, & Mingyi Hong, A Stochastic Linearized Augmented Lagrangian Method for Decentralized Bilevel Optimization, Advances in Neural Information Processing Systems (October 2022). Songtao Lu, Siliang Zeng, Xiaodong Cui, Mark S. Squillante, Lior Horesh, Brian Kingsbury, Jia Liu, & Mingyi Hong (2022 Nov. 29-Dec. 1), A Stochastic Linearized Augmented Lagrangian Method for Decentralized Bilevel Optimization [Conference presentation], 36^{th} Conference on Neural Information Processing Systems, New Orleans, LA, USA.

### BACKGROUND

There are many machine learning problems, meta-learning or meta reinforcement learning (“RL”), actor-critic (“AC”) schemes in RL, and hyperparameter optimization, which can be formulated mathematically as a multi-task hierarchical (bilevel) optimization problem. The idea behind the model design is that the upper-level model is considered as the meta learner that searches for a permutation-invariant subspace over multiple task-specific learners at the lower level so that the performance of the meta-learning model can be generalized well for unseen or testing data samples.

The existing theoretical analysis of the generalization performance of this class of bilevel problems has shown that meta-learning can indeed decrease the generalization error as the number of tasks increases, at least for strongly convex loss functions. Subsequently, a thorough ablation study from the latent representation perspective shows that feature reuse is the actual dominant factor in improving the generalization performance of meta learning. In the RL setting, AC structure in RL is a common learning framework that can be formulated by a bilevel optimization problem in nature, where the actor step at the upper level (actor network) aims at optimizing the policy while the critic step at the lower level is responsible for value function evaluation.

When multiple computational resources are available and connected, it is well motivated that exploring them solves distributed large-scale problems with a reduced amount of training time or performs multi-task learning. Under this setting, the multi-agent reinforcement learning (MARL) problem becomes a multi-objective optimization problem under provided (approximate) value functions, where the policy of each agent needs to be learned locally by certain efficient iterative methods. There are two issues with the existing systems: 1) the classic centralized training and decentralized execution paradigm need a central controller to approximate the value function, which is not practical in the fully decentralized setting; 2) even some works adopt the decentralized value function approximation and execute the policy improvement locally, which forgoes the permutation invariant latent space or the homogencity of the shared network environment.

The present disclosure is directed to overcoming these and other problems of the prior art.

### SUMMARY

Embodiments of the present invention address and overcome one or more of the above shortcomings and drawbacks, by providing systems and methods for bilevel decentralized multi-agent learning. Additional features and advantages of the invention will be made apparent from the following detailed description of illustrative embodiments that proceeds with reference to the accompanying drawings.

In an exemplary embodiment, a computer-implemented method of decentralized multi-agent learning for use in a system having a plurality of intelligent agents including a select intelligent agent and one or more other intelligent agents, each of the plurality of intelligent agent having a personal portion and a shared portion. The computer-implemented method includes, iteratively, until each of a personal goal and a network goal are optimized: determining, by the select intelligent agent, a feedback associated with an action conducted by the select intelligent agent relative to a personal goal and a degree of similarity relative to a shared goal; adjusting, by the select intelligent agent, a policy based on the feedback to gain a superior feedback from a next action, wherein the policy includes a personal policy associated with the select intelligent agent's personal portion and a shared policy associated with the select intelligent agent's shared potion; broadcasting, by the select intelligent agent to at least one of the one or more other intelligent agents, the shared policy; receiving, by the select intelligent agent, from at least one of the one or more other intelligent agents, the at least one of the one or more other intelligent agents' shared policy; generating, by the select intelligent agent, a combined policy by combining the personal policy and the at least one of the one or more other intelligent agents' shared policy; estimating, by the select intelligent agent, using the combined policy, a network value function; and conducting, by the intelligent agent, the next action in accordance with the combined policy.

In some embodiments, the personal goal is to maximize the feedback of the select intelligent agent, and the shared goal is to maximize the average feedback of the plurality of intelligent agents. In some embodiments, the select intelligent agent includes a neural network includes one or more of a first layer and a first several layers, and a plurality of remaining layers, and the shared portion includes the one or more of a first layer and a first several layers and the personal portion includes the plurality of remaining layers. In some embodiments receiving the at least one of the one or more other intelligent agents' shared policy includes receiving, by the select intelligent agent, a respective shared policy from each of the one or more other intelligent agents. In some embodiments the one or more other intelligent agents includes one or more neighboring intelligent agents and one or more non-neighboring intelligent agents and receiving the at least one of the one or more other intelligent agents' shared policy includes receiving, by the select intelligent agent, a respective shared policy from each of the neighboring intelligent agents. In some embodiments, a distinction between the one or more neighboring intelligent agents and the one or more non-neighboring intelligent agents includes a distance threshold. In some embodiments, generating the combined policy includes combining the personal policy and the at least one of the one or more other intelligent agents' shared policy using a convex combination. In some embodiments, the convex combination is one of uniform weights, Laplacian weights, a maximum degree weight, a Metropolis-Hastings algorithm, a least-mean square consensus weight rule, and a relative degree (-variance) rule.

In another exemplary embodiment, a decentralized multi-agent learning system includes a plurality of intelligent agents, wherein each of the plurality of intelligent agents includes a personal portion and a shared portion, wherein each respective intelligent agent of the plurality of intelligent agents is configured to, iteratively, until each of a personal goal and a network goal are optimized: determine a feedback associated with an action conducted by the respective intelligent agent relative to a personal goal and a degree of similarity relative to a shared goal; adjust a policy based on the feedback to gain a superior feedback from a next action, wherein the policy includes a personal policy associated with the personal portion and a shared policy associated with the respective intelligent agent's shared potion; broadcast the shared policy to at least one of one or more other intelligent agents of the plurality of intelligent agents in the decentralized multi-agent learning system; receive, from at least one of the one or more other intelligent agents of the plurality of intelligent agents, the at least one of the one or more other intelligent agents' shared policy; generate a combined policy by combining the personal policy and the at least one of the one or more other intelligent agents' shared policy; estimate a system value function using the combined policy; and conduct a next action in accordance with the combined policy.

In some embodiments, the personal goal is to maximize the feedback of the respective intelligent agent, and the shared goal is to maximize the average feedback of the plurality of intelligent agents. In some embodiments, the select intelligent agent includes a neural network includes one or more of a first layer and a first several layers, and a plurality of remaining layers, and the shared portion includes the one or more of a first layer and a first several layers and the personal portion includes the plurality of remaining layers. In some embodiments, the one or more other intelligent agents includes one or more neighboring intelligent agents and one or more of non-neighboring intelligent agents, wherein a distinction between the one or more neighboring intelligent agents and the one or more non-neighboring intelligent agents includes a distance threshold, and the receiving the at least one of the one or more other intelligent agents' shared policy includes receiving, by the respective intelligent agent, a respective shared policy from each of the neighboring intelligent agents.

In yet another exemplary embodiment, an intelligent agent for use in a decentralized learning system having one or more other intelligent agents includes one or more neural networks, each of the one or more neural networks including a personal portion and a shared portion, one or more of the one or more neural networks configured to iteratively, until each of a personal goal and a network goal are optimized: determine a feedback associated with an action conducted by the intelligent agent relative to a personal goal and a degree of similarity relative to a shared goal; adjust a policy based on the feedback to gain a superior feedback from a next action, wherein the policy includes a personal policy associated with the personal portion and a shared policy associated with the shared potion; broadcast the shared policy to at least one of the one or more other intelligent agents in the decentralized learning system; receive, from at least one of the one or more other intelligent agents in the decentralized learning system, the at least one of the one or more other intelligent agents' shared policy; generate a combined policy by combining the personal policy and the at least one of the one or more other intelligent agents' shared policy; estimate a system value function using the combined policy; and conduct the new action in accordance with the combined policy.

In some embodiments, the personal goal is to maximize the feedback of the intelligent agent, and the shared goal is to maximize the average feedback of the one or more other intelligent agents. In some embodiments, the select intelligent agent includes a neural network includes one or more of a first layer and a first several layers, and a plurality of remaining layers, and the shared portion includes the one or more of a first layer and a first several layers and the personal portion includes the plurality of remaining layers. In some embodiments, the intelligent agent includes an actor network and a critic network and the personal portion includes one or more of the actor network, the critic network, and both the actor network and the critic network. In some embodiments, the receiving the at least one of the one or more other intelligent agents' shared policy includes receiving, by the intelligent agent, a respective shared policy from each of the one or more other intelligent agents. In some embodiments, the one or more other intelligent agents includes one or more neighboring intelligent agents and one or more of non-neighboring intelligent agents and the receiving the at least one of the one or more other intelligent agents' shared policy includes receiving, by the intelligent agent, a respective shared policy from each of the neighboring intelligent agents. In some embodiments, a distinction between the one or more neighboring intelligent agents and the one or more non-neighboring intelligent agents includes a distance threshold. In some embodiments, the generating the combined policy includes combining the personal policy and the at least one of the one or more other intelligent agents' shared policy using a convex combination.

This summary is provided to introduce a selection of concepts in a simplified form that are further described below in the detailed description. This summary is not intended to identify key features or essential features of the claimed subject matter, nor is it intended to be used to limit the scope of the claimed subject matter. Additional features and advantages of the disclosed technology will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 is a block diagram of an example computing environment for bilevel decentralized multi-agent learning, according to certain embodiments of the disclosed technology;

FIG. 2 is a diagram of a bilevel decentralized multi-agent learning system, according to certain embodiments of the disclosed technology;

FIG. 3 is a diagram of a Markov decision process that can be performed by an intelligent agent, according to certain embodiments of the disclosed technology;

FIG. 4 is a diagram of how a neural network can be partitioned into a shared portion and a personal portion, according to certain embodiments of the disclosed technology;

FIG. 5 is a flow chart of a method of learning using a bilevel decentralized multi-agent learning system, according to certain embodiments of the disclosed technology;

FIG. 6 is a diagram of a bilevel decentralized multi-agent learning system completing a cooperative navigation task, according to certain embodiments of the disclosed technology;

FIGS. 7A-7E are graphs of average reward as a function of episodes during a cooperative navigation task for variations of decentralized learning systems, according to certain embodiments of the disclosed technology;

FIG. 8 is a diagram of a cooperative pursuit-evasion task, according to certain embodiments of the disclosed technology; and

FIGS. 9A and 9B are graphs of average reward as a function of episodes during a cooperative pursuit-evasion task for variations of decentralized learning systems, according to certain embodiments of the disclosed technology.

### DETAILED DESCRIPTION

Examples of the present disclosure related to systems and methods for bilevel decentralized multi-agent learning. More particularly, the disclosed technology relates to a fully decentralized method for robust policy improvement and value function estimation in multi-agent learning systems. The systems and methods described herein utilize, in some instances, machine learning models, which are necessarily rooted in computers and technology. Machine learning models are a unique computer technology that involves training models to complete tasks and make decisions. The present disclosure details a fully decentralized method for robust policy improvement and value function estimation in multi-agent learning systems. This is a clear advantage and improvement over prior technologies that require a central controller to approximate the value function, which is not practical in the fully decentralized setting, or that adopt the decentralized value function approximation and execute the policy improvement locally, which forgoes the permutation invariant latent space or the homogeneity of the shared network environment. The present disclosure solves this problem by including a consensus constraint for model parameter sharing at each of the upper-level and lower-level problems and coupling multiple lower-level problems with the upper-level problem, in some embodiments using a Stochastic Linearized Augmented Lagrangian Method. Overall, the systems and methods disclosed have significant practical applications in the field of multi-agent learning because of the noteworthy improvements of the fully decentralized methods disclosed herein, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se. such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

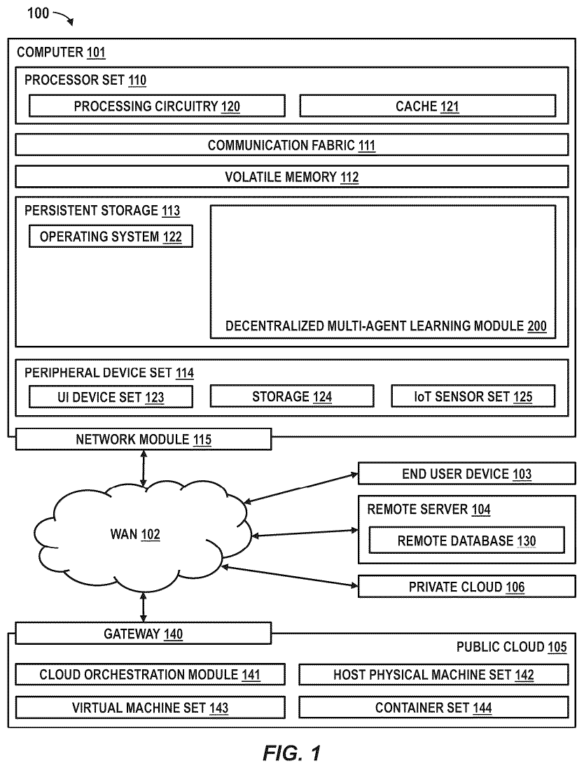

With reference now to FIG. 1, computing environment 100 contains an example of an environment for the execution of at least some of the computer code involved in performing the inventive methods, such bilevel decentralized multi-agent learning. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The technology disclosed herein considers a very general decentralized hierarchical learning setting with a focus on MARL problem, where both the upper-level and lower-level problems can include a consensus constraint for model parameter sharing and there would be multiple lower-level problems coupled with the upper-level problem. To solve this problem efficiently in a fully decentralized way, in some embodiments, a Stochastic Linearized Augmented Lagrangian Method (SLAM) for dealing with both levels of the optimization processes and the consensus constraints at each level can be used. Leveraging the linearized augmented Lagrangian function as a surrogate, the design of SLAM is simple and easily implemented as it is a single-loop algorithm with only step sizes to be tuned for convergence. The standard assumptions on Lipschitz continuity and convexity for both the UL and LL optimization problems as shown in the existing literature can be made. The conditions of SLAM can be established with respect to convergence to Karush-Kuhn-Tucker (KKT) points of this problem and show the linear speed up with respect to the number of agents for joint policy improvement and value function approximation.

From the system design perspective, the proposal SLAM allows a partial average of the policy network under the model parameter sharing consensus constraint at both levels of the problem (policy improvement and value function approximation). Theoretically, the proposed SLAM method achieves the same convergence rate as the standard decentralized SGD type of algorithm for only single-level nonconvex minimization problems. Remarkably, through numerous numerical experiments on MARL problems, it is observed that SLAM can converge faster than the existing MARL methods and even achieve higher rewards in some cases, and the convergence behavior of SLAM is much more robust w.r.t. hyperparameters comparing with the existing methods.

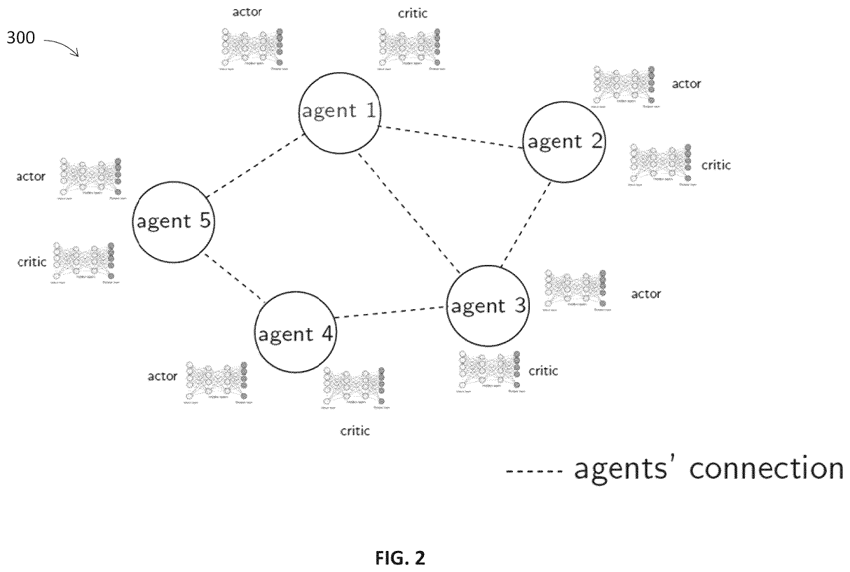

Accordingly, systems and methods for bilevel decentralized multi-agent learning are disclosed herein. FIG. 2 is a diagram of a bilevel decentralized multi-agent learning system 300, according to certain embodiments of the disclosed technology. In some embodiments, the bilevel decentralized multi-agent learning system 300 is a hierarchical learning system. In some embodiments, the system 300 can include intelligent agents and a communication network. In some embodiments, an intelligent agent can include a local actor (policy network) neural network for policy improvement and a local critic (critical network) neural network for value function approximation. The communication network can allow parameter sharing among neighboring intelligent agents over a well-connected graph. In some embodiments, the actor neural network can be partitioned into two parts: a shared part that can be shared with the neighboring intelligent agents and a personal part for adapting to the local environment. Each intelligent agent can implement individual updates for both actor-critic neural networks by combing the neighbors' model parameters with its own model parameters. In some embodiments, the algorithms for model updates can be either deterministic or stochastic.

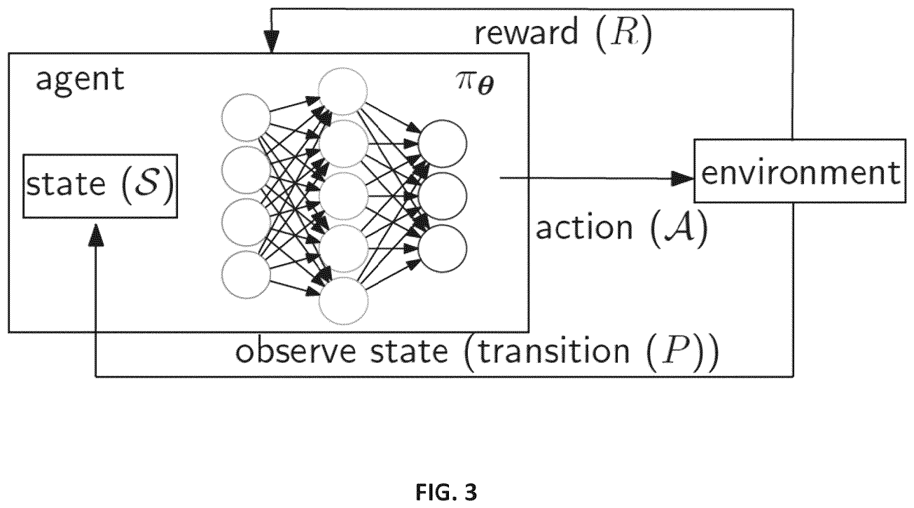

FIG. 3 is a diagram of a Markov decision process that can be performed by an intelligent agent, according to certain embodiments of the disclosed technology. In some embodiments, each of the policy network and the critical network can utilize a Markov decision process (“MDP”). With reference to FIG. 3, consider a networked MDP (S, {A₁, ∀ᵢ}, P, {Rᵢ, ∀ᵢ}, η, [symbol] , γ). S denotes the global states shared by all intelligent agents, Aᵢ is the action space of intelligent agent i, A=Πᵢ₌₁ⁿAᵢ is the joint action space of all intelligent agents, P: S×A×S→[0,1] is the state transition probability of the nMDP, Rᵢ(s, a): S×A→ [symbol] , ∀ᵢ denote the local rewards, η(s) denotes the initial state, [symbol] is the communication graph, and γ∈(0,1) stands for the discount factor. It is assumed that S and actions a are globally observable. The goal of the bilevel decentralized multi-agent learning system described herein is to learn a joint policy π_{θ} parametrized by θ such that the networked reward function is maximized.

The discounted accumulative reward function maximization problem with respect to optimizing the policy is max_{θ}J(θ)

$$\begin{matrix}J ( θ ) {=}^{△} \frac{1}{n} {\sum }_{i = 1}^{n} [ {\sum }_{r = 0}^{∞} {γ}^{r} {R}_{i} ( {s}^{r} , {a}^{r} ) \vert {s}^{0} = s , {a}^{0} = a ] \\ = [ {\sum }_{r = 0}^{∞} {γ}^{r} \overline{R} ( {s}^{r} , {a}^{r} ) \vert {s}^{0} = s , {a}^{0} = a ] \\ = {η ( s )}_{} [ {V}_{{π}_{θ}} ( s ) ]\end{matrix}$$

where R̅(s, a)=n⁻¹Σᵢ₌₁ⁿ Rᵢ(s, a), the expectation is taken over all the trajectories generated by policy π_{θ}, and value function

$${V}_{{π}_{θ}} ( s ) {=}^{△} [ {\sum }_{r = 0}^{∞} {γ}^{r} \overline{R} ( {s}^{r} , {a}^{r} ) \vert {s}^{0} = s ] .$$

Given policy π_{θ}, value function V_{π}_{_{θ}}(s) satisfies the Bellman equation:

$${V}_{{π}_{θ}} = {a \sim {{π}_{θ} ( \cdot \vert s )}_{, {s}^{′} \sim P} ( \cdot \vert s , a )}_{} [ \overline{R} ( s , a ) + γ {V}_{{π}_{θ}} ( {s}^{′} ) ] .$$

The technology disclosed herein is a learning framework to perform both policy improvement and value function approximation over a network.

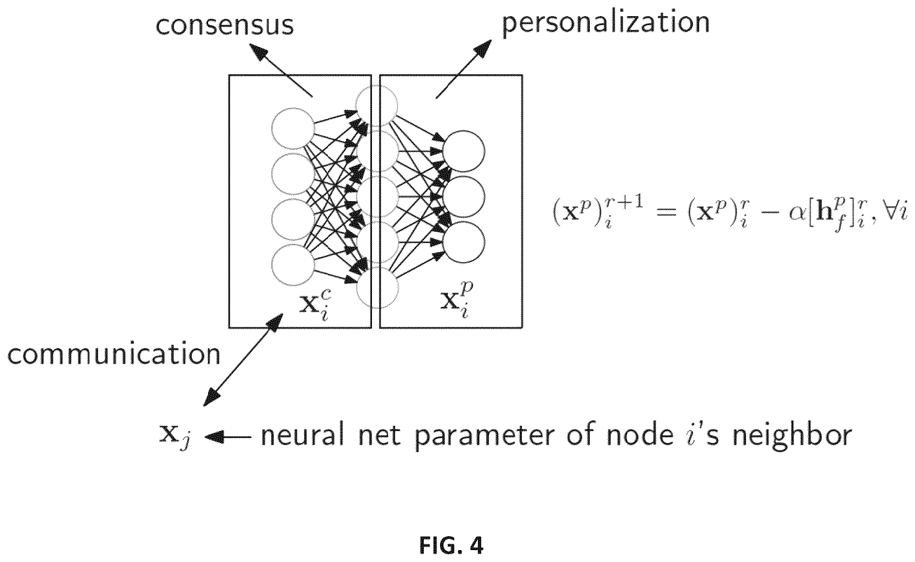

FIG. 4 is a diagram of how a network can be partitioned into a shared portion and a personal portion, according to certain embodiments of the disclosed technology. The partitioning scheme employed herein can involve partitioning each intelligent agent's weights into two distinct parts. The shared portion can enable consensus by being combined with the weights of other intelligent agents, while the personal portion is exclusively utilized by the intelligent agent itself. In some embodiments, the partitioning strategy can be flexible and tailored according to specific requirements. By offering this versatility in partitioning, the approach can accommodate diverse scenarios and facilitates effective personalization within the neural network architecture.

In some embodiments, a first layer (or first several layers) can be the shared portion utilized to foster consensus among the intelligent agents and the remaining layers can be the personal portion utilized for personalized feature extraction and adaptation. In this context, the nodes in the network are interconnected in an ad hoc manner, devoid of any priority at the node-level. In some embodiments, personalization can be achieved through the partitioning of the neural network at each node, enabling customization and adaptation. There is no requirement for equal weight allocation during the partitioning process. The partitioning can be performed selectively in various ways, including, for example, solely focusing on the actor network, exclusively targeting the critic network, and encompassing both the actor and critic networks.

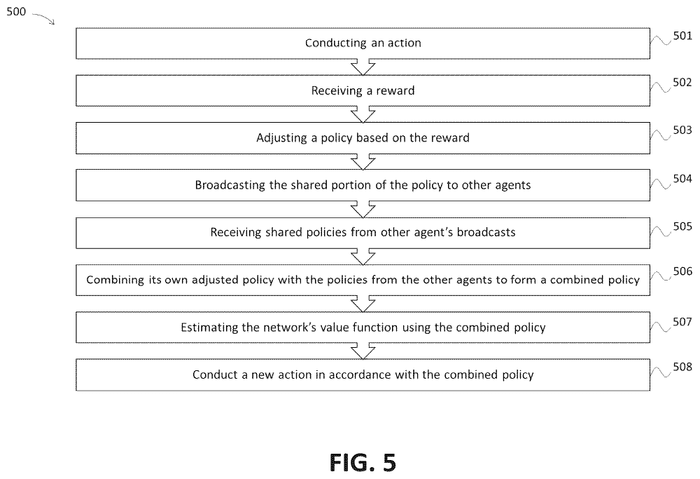

FIG. 5 is a flow chart of a method 500 of learning using a bilevel decentralized multi-agent learning system, according to certain embodiments of the disclosed technology. The method 500 illustrated in FIG. 5 is from the perspective of one intelligent agent, e.g., Agent 1. At step 501, the method 500 can include conducting an action. For example, consider a situation in which Agent 1 is a drone equipped with sensors and navigation abilities tasked with navigating through an environment to reach a target location. At step 501, Agent 1 moves forward (or turn left, right, move backward, or stay). At step 502, the method 500 can include receiving feedback (e.g., a reward) associated with the action taken at step 501, with the primary objective of the system 300 being to optimize the sum of the individual rewards of the intelligent agents in the system 300. For example, Agent 1 can compare the actions of moving in other directions to its personal goal of reaching a target location in the shortest possible time and to the global goal of avoiding collisions and efficient navigation.

At step 503, the method 500 can include adjusting a policy based on the feedback to gain a superior feedback for the next action by conducting an action to bring the intelligent agent closer to achieving its personal goal and the global goal. For example, based on the feedback determined at step 502, the Agent 1 can adjust its parameters or policy through the actor neural network to ensure that the next action brings Agent 1 closer to its personal goal of reaching a target location in the shortest possible time and to the global goal of avoiding collisions and efficient navigation. In some embodiments, an intelligent agent's policy can include a personal policy and a shared policy. The personal policy may be associated with the intelligent agent's personal portion, and the shared policy may be associated with the intelligent agent's shared portion. Once the intelligent agent's policy (which includes both the personal policy and the shared policy) is adjusted at step 504, the method 500 can include broadcasting its shared policy to other intelligent agents in the system 300. For example, Agent 1 can broadcast its updated parameters or policy of both the actor and critic neural networks to other intelligent agents in the system 300.

As used herein and in some embodiments, a “policy” is essentially a mapping, such as a function, that connects the state space to the action space. In practical terms, this mapping can be initially unknown and need to be learned. To accomplish this, in some embodiments, a neural network can be employed to approximate the policy mapping. In other words, the policy is parameterized by the neural network, and the “weights” within the network serve as the learnable parameters. These parameters, also known as the model parameters or “parameters,” represent the weights of the neural network. In some of the embodiments of the solution disclosed herein, the policy concept is central, and the model parameters, embodied by the neural network weights, are the learnable variables that require optimization during the learning process.

As mentioned above, the method 500 described herein with respect to FIG. 5 is from the perspective of one intelligent agent. Thus, in a system 300, several intelligent agents can be performing the method 500. As such, in some embodiments, several intelligent agents are updating and broadcasting their shared policies to other intelligent agents in the system 300. Therefore, at step 504, the method 500 can include receiving the shared policies of other intelligent agents. For example, Agent #1 can receive shared policies of other intelligent agents in the system 300.

In some embodiments, shared policies are broadcasted and received by all intelligent agents in the system 300, resulting in a fully connected communication graph. However, in some embodiments, the shared policies can be broadcasted or received amongst only neighboring intelligent agents. This flexibility can encompass a wide range of graph topologies, enabling diverse communication patterns. The determination of each intelligent agent's neighborhood can be approached in various ways. For instance, a straightforward approach can involve defining a threshold based on the distance between two intelligent agents. In the context of navigation learning tasks, one can utilize distance as a metric to establish whether two intelligent agents are considered neighbors or not. Referring back to FIG. 1, neighboring intelligent agents are connected by dotted lines. Therefore, Agent 1's neighbors are Agent 2, Agent 3, and Agent 5.

Returning to FIG. 5, at step 506, the method 500 can include combining the intelligent agent's own policy (which includes its shared and personal policies) with the shared policies of other intelligent agents it received at step 505. In some embodiments, the combination can be a convex combination of the weights of the policy, including, for example, uniform weights, Laplacian weights, maximum degree weight, Metropolis-Hastings, the least-mean square consensus weight rules, and the relative degree (-variance) rule. For example, Agent 1 can combine shared parameters received from neighboring intelligent agents with its own parameters to yield new parameters or an updated policy that takes into account both local (i.e., personal) and global information.

At step 507, the method 500 can include estimating the value function of the network of intelligent agents. For example, Agent 1 can estimate the value function, which represents the expective cumulative rewards or benefits associated with different actions, of the network through the critic network, using the new parameters or updated policy from step 506. At step 508, the method 500 can include conducting a new action in accordance with the new parameters or updated policy generated at step 506. For example, Agent 1 can perform another action, such as turning left or right, based on the new (combined) parameters or updated policy of the actor neural network from step 506. In some embodiments, the method 500 can be performed iteratively (the new action conducted at step 508 satisfying step 501 such that there is only one action or set of actions performed per iteration) until both the personal goal and the global goal are met, optimized, or maximized. The above examples demonstrate how Agent 1 (i.e., the drone) interacts with its environment and other intelligent agents to navigate to the target locations while considering its personalized goal and the global goal of efficient navigation.

Additional details regarding equations and diagrams relevant to some embodiments to the disclosed technology are described in the paragraphs that follow.

Bilevel optimization has been shown to be a powerful framework for formulating multi-task machine learning problems, e.g., reinforcement learning (RL) and meta learning, where the decision variables are coupled in both levels of the minimization problems. In practice, the learning tasks can be located at different computing resource environments, and thus there is a need for deploying a decentralized training framework to implement multi-agent and multi-task learning. Disclosed herein is a stochastic linearized augmented Lagrangian method (SLAM) for solving general nonconvex bilevel optimization problems over a graph, where both upper and lower optimization variables are able to achieve a consensus. The theoretical convergence rate of the proposed SLAM to the Karush-Kuhn-Tucker (KKT) points of this class of problems is on the same order as the one achieved by the classical distributed stochastic gradient descent for only single-level nonconvex minimization problems. Numerical results tested on multi-agent RL problems showcase the superiority of SLAM compared with the benchmarks.

Consider herein is the following general decentralized bilevel optimization (DBO) framework with applications to machine learning problems. Suppose that there are n nodes over a connected graph [symbol] ={ε, [symbol] }, where ε and [symbol] represent the edges and vertices. Let [symbol] denote the set of neighboring nodes for node i. Then the goal of DBO is to have these nodes jointly minimize two levels of optimization problems. More formally, DBO is expressed as

$${min}_{{x}_{1} , … , {x}_{n}} \frac{1}{n} {\sum }_{i = 1}^{n} {f}_{i} ( {x}_{i} , {y}_{i , 1}^{*} ( {x}_{i} ) , … , {y}_{i , m}^{*} ( {x}_{i} ) ) \qquad ( 1 a )$$

$$s . t . {x}_{i} = {x}_{j} , j ∈ , ∀ i ∈ [ n ] \qquad ( 1 b )$$

$${y}_{k}^{*} ( x ) = arg {min}_{{y}_{1 , k} , … , {y}_{n , k}} \frac{1}{n} {\sum }_{i = 1}^{n} {g}_{i , k} ( {x}_{i} , {y}_{i , k} ) s . t . {y}_{i , k} = {y}_{j , k} , j ∈ , ∀ k ∈ [ m ] , \qquad ( 1 c )$$

where vector xᵢ is the upper level (UL) optimization variable at each node i, vector y_{i,k} denotes the lower level (LL) decision variable for the kth learning task at node i, fᵢ(;) is a (smooth) UL loss function and possibly nonconvex with respect to (w.r.t.) both the UL and LL variables, g_{i,k}(.) denotes the LL objective function of the kth task at node i, [symbol] represents the total number of LL optimization problems, the consensus constraints xᵢ=xⱼ, y_{i,k}=y_{j,k}, j∈ [symbol] , ∀i∈[n], ∀k∈[m], enforce the model agreements at each level of the problems and for each LL learning task, and y*ₖ=[y*_{1,k}, . . . , y*_{n,k}]^{T} is the optimal solutions of the kth LL problem under the consensus constraints.

Applications of Bilevel Optimization: Many machine learning problems can be formulated mathematically as a form of bilevel optimization or, more precisely, a special case of problem (1), e.g., meta-learning or meta reinforcement learning (RL), actor-critic (AC) schemes in RL, hyperparameter optimization (HPO), and so on.

Classical bilevel optimization is referred to as the case where there is no consensus constraint but with only two levels of the minimization subproblems, i.e., minₓ f (x, y*(x)), s.t. y*(x)=arg min_{y} g(x, y), which is also known as Stackelberg games with the UL decision variable as the leader and the LL decision variable as the follower. It turns out that this class of optimization problems is useful in formulating a wide range of hierarchical or nested structured machine learning problems. For example, one of the most popular domain adaption learning models, model-agnostic meta-learning (MAML), can be written as a special case of bilevel programming, where the UL model provides a good initialization for accelerating learning procedures by implementing the LL algorithms. The idea behind the model design is that the UL model is considered as the meta learner that searches for a permutation-invariant subspace over multiple task-specific learners at the LL so that the performance of the MAML model can be generalized well for unseen or testing data samples. The theoretical analysis of the generalization performance of this class of bilevel problems has shown that MAML can indeed decrease the generalization error as the number of tasks increases, at least for strongly convex loss functions. Subsequently, a thorough ablation study from the latent representation perspective shows that feature reuse is the actual dominant factor in improving the generalization performance of MAML, and the inventors propose herein a neural network-oriented algorithm with almost no inner loop (ANIL) that splits the neural network parameters into two parts corresponding to the UL and LL optimization problems, respectively. Extensive numerical experiments illustrate that ANIL achieves almost the same accuracy as the classical MAML but with significant computational savings. This example further strengthens the necessity of variable splitting in the learning structure by optimizing two levels of objective functions to enhance the generalization performance. Beyond the traditional supervised meta-learning scenarios, MAML has also been applied to increasing the generalization ability of agents in RL problems by replacing the (stochastic) gradient with the (natural) policy gradient (PG) under the same two-level structure.

Besides meta-learning problems, AC structure in RL is another class of common learning frameworks that can be formulated by a bilevel optimization problem in nature, where the actor step at the UL aims at optimizing the policy while the critic step at the LL is responsible for value function evaluation. In addition, as the expressiveness of neural networks increased sharply over the past decades, the reuse of large models with adaptation to multi-task learning problems presents promising solutions by leveraging the pre-train and fine-tune strategy, such as in applications of HPO where the hyperparameters are trained at the UL problem so that the downstream learning tasks are learned with low costs including the expense of both computation and memory.

Applications of Multi-agent Settings: When multiple computational resources are available and connected, it is well motivated that exploring them solves distributed large-scale problems with a reduced amount of training time or performs multi-task learning. The bilevel structure of the meta-learning (ML) is a good fit in this scenario as either UL/LL or both levels may need to access the networked data samples rather than local ones. For example, a federated learning setting of MAML and bilevel optimization have been built up over multiple nodes recently, where the meta/UL learner finds an initial shared model while the local/LL learners leverage it for adapting data distributions of individual users. In such a way, the federated MAML model can realize personalized learning without sharing heterogeneous data over numerous clients. Once there is no central controller for coordinating the model aggregation, a diffusion-based MAML (Dif-MAML) and a personalized client learning strategy are proposed by spreading the model parameters over a network, where the UL parameter is updated by one step of stochastic gradient descent (SGD) based on a combination of the parameters of neighbors as the initialization for local model updates.

As one of ordinary skill in the art will appreciate, the setup of federated learning can be considered as a specific case within the broader decentralized learning framework. In federated learning, a central controller can be responsible for connecting a set of local nodes or learners, resulting in a star-shaped topology. Conversely, in the solution described herein, the graph structure can be arbitrary, with the condition that the nodes are sufficiently connected. This means that any node within the graph can access any other node through a finite number of traversal steps. This is in contrast to the federated learning setting, in which all the nodes are required to establish a connection with the server, leading to a distinctive/specific connectivity pattern among the learners.

Decentralized hierarchical structured learning is even more stringent in the multi-agent RL (MARL) setting as the learning tasks are essentially located at scattered sensors and/or controllers. Under this setting, MARL problem becomes a multi-objective optimization problem under provided (approximate) value functions, where the policy of each agent is learned locally by certain efficient iterative methods, such as multi-agent deep deterministic policy gradient (MADDPG), trust region methods, optimal baseline based variance reduced policy gradient, and/or improved by more advanced techniques, e.g., constrained policy optimization and large sequence models. In such a way, the total reward can be maximized over the distributed agents through optimizing the networked policy. In a fully collaborative setting, the team-based value function is even required to be shared over all the agents such that each agent is able to improve its policy based on the estimated total reward. For example, the decentralized AC (DAC) scheme has been investigated widely, where each agent uses the actor step to optimize its policy while the critic step performs one step or multiple steps of temporal difference learning with mini-batch sampling (MDAC) and communications so that the team-based reward over the network is obtained by each agent. However, these works only extend the classic centralized AC scheme to the networked setting directly. Consequently, they overlook the most distinct challenge of decentralized learning. i.e., the heterogeneity of the network. On the other hand, SLAM incorporates both personal and global goals throughout the learning process, which effectively addresses the balance between adapting to local learning features and achieving consensus for global model aggregation.

It turns out that DAC can be formulated as a special case of problem (1) as there is no consensus at the UL. If there exists homogeneity of the state and action spaces, decentralized policy consensus (or a partial policy parameter sharing strategy) provides significant merits to the centralized training and decentralized execution paradigm in terms of learning scalability and efficiency, which motivates the consensus process at both UL and LL DBO problems.

Conventional Works: Given the fruitful results across these many applications, the corresponding theoretical analysis has been developing very fast as well for variants of bilevel optimization problems. For example, the convergence behaviors of classical inexact MAML (iMAML) methods have been quantified for both convex and nonconvex cases of the UL loss function, where the LL algorithm only performs one step of stochastic gradient descent (SGD) based on the LL objective functions as the adaptation step. Moreover, the iteration complexity of ANIL with multiple iterations for minimizing the LL problems have been studied in, which justifies the significant computational advantages of ANIL compared with MAML in theory. Furthermore, the finite-time analysis of AC algorithms has shown that, once the learning rates at both the actor and critic sides are chosen properly, a two timescale AC algorithm can achieve an [symbol] (ϵ^{-2.5}) iteration complexity for finding the first-order stationary points (FOSPs) of general nonconvex reward functions.

Besides these theoretical analyses in a specific learning setting, the algorithm design and corresponding convergence analysis for general bilevel optimization solvers have been recently advancing at a rapid pace under certain assumptions that the UL objective function is general nonconvex while the LL objective functions are strongly convex, which covers the existing convergence results shown for AC algorithms. The conventional algorithms include those with double-loop structure, those with two timescale or single timescale but single-loop, and those with error-correction or accelerated/variance-reduction. To be more specific, double-loop algorithms, such as bilevel stochastic approximation (BSA) methods and stochastic bilevel optimizers (stoBiO), mainly request an inner loop to solve the LL problem up to a certain error tolerance or with a certain number of iterations and then switch back to optimize the UL problem, which can achieve an [symbol] (ϵ⁻²) convergence rate to the e-FOSPs. In practice, single-loop algorithms are implemented more efficiently in terms of computational complexity and hyperparameter tuning compared to double-loop algorithms. A two-timescale stochastic approximation (TTSA) was analyzed in another work, but it is shown that TTSA needs [symbol] (ϵ^{-2.5}) number of iterations to achieve the E-FOSPs. Later, an error correction method, named the Single-Timescale stochAstic BiLevEl optimization (STABLE) method, improves the convergence rate of the single-loop algorithm to [symbol] (ϵ⁻²) and a tighter analysis for ALternating Stochastic gradient dEscenT (ALSET) shows that the single-loop algorithm can also achieve a convergence of [symbol] (ϵ⁻²) without the error correction technique. When more advanced momentum-assisted or variance reduction methods are adopted in the algorithm design, the subsequent works, such as the momentum-based recursive bilevel optimizer (MRBO) and the single-timescale double-momentum stochastic approximation (SUSTAIN) and the variance reduced BiAdam (VR-BiAdam), can sharpen the convergence rate of bilevel algorithms to [symbol] (ϵ^{-1.5}).

For the theoretical works on MAML/MARL, it is shown in that when the critic side is allowed the consensus step at each agent to approximate the networked rewards, MDAC algorithms can achieve an [symbol] (ϵ⁻²) convergence rate to FOSPs, but both of them require an inner loop procedure for the LL problem which makes the algorithms double loop. Dif-MAML is able to perform the UL consensus-based meta learning, but iMAML considered in Dif-MAML is only a very special case of bilevel. Thus, the applicability of Dif-MAML is restrictive. Referring specifically to AC, AC (CAC) can realize the consensus on both UL and LL problems with [symbol] (ϵ^{-2.5}) number of iterations and is only for DAC problems. A theoretical comparison between the solution disclosed herein and conventional works on bilevel programming is shown in Table 1. There is a line of independent work on decentralized optimization. But the conventional works are only suitable for single-level minimization of only nonconvex problems, such as distributed SGD, stochastic gradient tracking and stochastic primal dual algorithm, which can achieve an [symbol] (1/(nϵ²)) convergence rate to FOSPs for general nonconvex objective function optimization problems.

TABLE 1
A comparison with conventional work on (decentralized) bilevel optimization
learning. “Comm.” refer to whether the algorithm only needs
one round of communication at either UL or LL per iteration; “Alg.”
refs to the types of the basic stochastic algorithms adopted in the method.

| Conventional | Consensus | | | | | | |
|---|---|---|---|---|---|---|---|
| work | UL | LL | Method | Rate | Comm. | Alg. | Setting |
| A | | | BSA | [symbol] (1/∈²) | — | SGD | bilevel |
| B | | | TTSA | [symbol] (1/∈^{2.5}) | — | SGD | bilevel |
| C | | | ALSET | [symbol] (1/∈²) | — | SGD | bilevel |
| D | | | SUSTAIN | [symbol] (1/∈^{1.5}) | — | Momentum | bilevel |
| E | ✓ | | Dif-MAML | [symbol] (1/∈²) | ✓ | SGD | iMAML |
| F | | ✓ | DAC | — | ✓ | PG | MARL |
| G | | ✓ | MDAC | [symbol] (1/∈²) | | PG | MARL |
| H | | ✓ | MDAC | [symbol] (1/∈²) | | PG | MARL |
| I | ✓ | ✓ | CAC | [symbol] (1/∈^{2.5}) | ✓ | PG | MARL |
| This work | ✓ | ✓ | SLAM | [symbol] (1/n∈²)) | ✓ | SGD/PG | bilevel |

Advantages of The Solution Disclosed Herein: Considered herein is a very general DBO setting, where both UL and LL problems can include a consensus constraint for model parameter sharing and there would be multiple LL problems coupled with the UL problem. To solve this problem efficiently in a fully decentralized way, a Stochastic Linearized Augmented Lagrangian Method (SLAM) is disclosed for dealing with both of the two levels of the optimization processes and the consensus constraints at each level. Leveraging the linearized augmented Lagrangian function as a surrogate, the design of SLAM is simple and easily implemented as it is a single-loop algorithm with only step sizes to be tuned for convergence. The standard assumptions on Lipschitz continuity and convexity for both the UL and LL optimization problems as shown in the existing literature can be made. The conditions of SLAM are established w.r.t. convergence to e-Karush-Kuhn-Tucker (KKT) points of problem (1) at a rate of [symbol] (1/(nϵ²)), matching the standard convergence rate achieved by decentralized SGD type of algorithm to FOSPs for only single-level nonconvex minimization problems.

Remarkably, through numerical experiments on MARL problems, it is observed that SLAM can converge faster than the existing MARL methods and even achieve higher rewards in most cases.

To summarize, the advantages of the solution disclosed herein include at least the following: One, the SLAM algorithm is generic, and thus generalizes the single agent-based bilevel algorithms to the multi-agent setting and is amenable to be specialized to solve multiple consensus-based DBO problems. Two, SLAM is a single-timescale and single-loop algorithm that can find the E-KKT points at a rate of [symbol] (1/(nϵ²)), which shows a linear speedup w.r.t. the number of nodes. This is the first work that shows a decentralized stochastic algorithm can achieve this rate under the constraints where any level or both levels of the DBO problem requires the consensus process. Three, numerical results that illustrate the proposed SLAM outperforms the state-of-the-art MARL algorithms over heterogeneous networks in terms of both convergence speed and achievable rewards.

The following paragraphs explain a decentralized bilevel optimization framework.

Problem formulation of DBO: One of the main motivations for performing decentralized joint learning is dealing with large-scale dataset or scattered data samples. At each node, the loss function can be written as fᵢ(xᵢ, y*_{i,1}(xᵢ), . . . , y*_{i,m}(xᵢ))

[symbol]

$$[ {F}_{i} ( {x}_{i} , {y}_{i , 1}^{*} ( {x}_{i} ) , … , {y}_{i , 𝓂}^{*} ( {x}_{i} ) ; ξ ) ] ,$$

where [symbol] denotes the local data distributions at the UL optimization problem, and Fᵢ(xᵢ, y*_{i,1}(xᵢ), . . . , y*_{i,m}(xᵢ); ξ) represents the estimation error of the UL learning model on data ξ∈ [symbol] . Similarly, the LL Learning tasks also include randomly sampled data from a local distribution [symbol] for task k, so the LL cost function at each node can be expressed as

$${g}_{i , k} ( {x}_{i} , {y}_{i , k} ) {=}^{△} [ {G}_{i , k} ( {x}_{i} , {y}_{i} ; ζ ) ] , ∀ k ,$$

where G_{i,k} denotes the estimation error of the LL learning model over y_{k,i} on data λ∈ [symbol] . SGD is one of the most efficient algorithms for tackling large amounts of data samples. Before showing the algorithm design, reformulate problem (1) is reformulated in a concise and compact way from a global view of the variables. Let x [symbol] [x₁, . . . , xₙ]^{T} and yₖ [symbol] [y_{1,k}, . . . , y_{n,k}]^{T}. Then, problem (1) can be rewritten by concatenated variables as

$${min}_{x} f ( x , {y}_{k}^{*} ( x ) ) {=}^{△} \frac{1}{n} {\sum }_{i = 1}^{n} {f}_{i} ( {x}_{i} , {y}_{i , k}^{*} ( {x}_{i} ) ) \qquad ( 2 a )$$

$$s . t . Ax = 0 , \qquad ( 2 b )$$

$${y}_{k}^{*} ( x ) = arg {min}_{{y}_{k}} {g}_{k} ( x , {y}_{k} ) {=}^{△} \frac{1}{n} {\sum }_{i = 1}^{n} {g}_{i , k} ( {x}_{i} , {y}_{i , k} ) s . t . {Ay}_{k} = 0 , ∀ k ∈ [ m ] , \qquad ( 2 c )$$

where gₖ(x, yₖ) denotes the kth LL loss function, A∈ [symbol] represents the incidence matrix and fᵢ(xᵢ, y*_{i,k}(xᵢ)) abbreviates fᵢ(xᵢ, y*_{i,1}(xᵢ), . . . , y*_{i,m}(xᵢ)) for notational brevity. The incidence matrix assumes that the problem dimension is 1, without loss of generality, to simplify the notation.

Algorithm Design: Towards this end, a variant of the classical augmented Lagrangian function for the UL optimization problem can be constructed as the following:

$${ℒ}_{ργ} ( x , λ ) = f ( x , {y}_{k}^{*} ( x ) ) + γ 〈 λ , Ax 〉 + \frac{ργ}{2} {‖ Ax ‖}^{2} , \qquad ( 3 )$$

where λ denotes the dual variable (Lagrangian multiplier) for the consensus constraint, ρ>0, and γ is a scaling factor (which can be determined later).

Motivated by the primal-dual optimization framework, one step of gradient descent based on the linearized objective function with a following gradient ascent step is sufficient for the minimization of the general nonconvex loss function under the linear constraints, which means that there is no need to solve an inner optimization problem before updating the Lagrangian multiplier as is done in the classical augmented Lagrangian method.

When both the UL and LL objective functions are differentiable and the inverse of the Hessian matrix at the LL problem exists, i.e., ∇_{y}_{ₖ}_{y}_{ₖ}²gₖ(x, y*ₖ(x)) is invertible, then there exists a closed form for ∇fᵢ(xᵢ, y*_{i,k}(xᵢ)). Following the existing works on bilevel algorithm designs, replacing y*_{i,k}(xᵢ) by y_{i,k} in the gradient of fᵢ(xᵢ, y*_{i,k}(xᵢ)) w.r.t. xᵢ can serve as an efficient surrogate for the stochastic gradient estimate. However, in the decentralized setting, only individual loss functions are observable at each agent, therefore, the local UL implicit gradient can be computed through replacing gₖ(x, yₖ) by g_{i,k}(xᵢ, y_{i,k}), denoted as ∇fᵢ(xᵢ, y_{i,k}). Let h_{g,k}^{r} and h_{f}^{r} respectively denote the distributed stochastic gradient estimate of the LL and UL objective functions at points (x^{r}, yₖ^{r}) and (x^{r}, yₖ^{r+1}), ∀k, w.r.t. yₖ and x, where r represents the index of iterations. Thus, the proposed SLAM can be expressed as

$${y}_{k}^{r + 1} = arg {min}_{{y}_{k}} 〈 {h}_{g , k}^{r} + γ {A}^{T} ( {ω}_{k}^{r} + ρ {Ay}_{k}^{r} ) , {y}_{k} - {y}_{k}^{r} 〉 + \frac{β}{2} {‖ {y}_{k} - {y}_{k}^{r} ‖}^{2} , ∀ k , \qquad ( 4 a )$$

$${ω}_{k}^{r + 1} = {ω}_{k}^{r} + \frac{ρ}{γ} {Ay}_{k}^{r + 1} , ∀ k , \qquad ( 4 b )$$

$${x}_{r + 1} = arg {min}_{x} 〈 {h}_{f}^{r} + γ {A}^{T} ( {λ}^{r} + ρ {Ax}^{r} ) , x - {x}^{r} 〉 + \frac{α}{2} {‖ x - {x}^{r} ‖}^{2} , \qquad ( 4 c )$$

$${λ}^{r + 1} = {λ}^{r} + \frac{ρ}{γ} {Ax}^{r + 1} , \qquad ( 4 d )$$

where ωₖ is the dual variable for ensuring the LL consensus process for each learning task, α and β are the parameters of the quadratic penalization terms, and ρ/γ here is the step-size for the updates of the dual variables.

Implementation of SLAM: Noting that the objective functions in each subproblem, i.e., (4a) and (4c), are quadratic, both UL and LL optimization variables be updated as the following:

$${y}_{k}^{r + 1} = {y}_{k}^{r} - \frac{1}{β} ( {h}_{g , k}^{r} + γ {A}^{T} {ω}_{k}^{r} + ργ {A}^{T} {Ay}_{k}^{r} ) , ∀ k , \qquad ( 5 a )$$

$${x}^{r + 1} = {x}^{r} - \frac{1}{α} ( {h}_{f}^{r} + γ {A}^{T} {λ}^{r} + ργ {A}^{T} {Ax}^{r} ) , \qquad ( 5 b )$$

where 1/α and 1/β serve as the step-sizes of updating both UL and LL learning models.

Subtracting the equality with the same one from the previous iteration for both (5a) and (5b) ends up with efficient model updates of both the UL and LL learning problems as follows:

$${y}_{k}^{r + 1} = 2 {W}_{g} {y}_{k}^{r} - {W}_{g}^{′} {y}_{k}^{r - 1} - \frac{1}{β} ( {h}_{g , k}^{r} - {h}_{g , k}^{r - 1} ) , ∀ k , \qquad ( 6 a )$$

$${x}^{r + 1} = 2 {W}_{f} {x}^{r} - {W}_{f}^{′} {x}^{r - 1} - \frac{1}{α} ( {h}_{f}^{r} - {h}_{f}^{r - 1} ) , \qquad ( 6 b )$$

where the mixing matrices, with τ_{g} =β/γ and τ_{f}=α/γ, are defined as

$${W}_{g} {=}^{△} I - \frac{( 1 + {γ}^{- 1} ) ρ}{2 {τ}_{g}} {A}^{T} A , {W}_{g}^{′} {=}^{△} I - \frac{ρ}{{τ}_{g}} {A}^{T} A , \qquad ( 7 a )$$

$${W}_{f} {=}^{△} I - \frac{( 1 + {γ}^{- 1} ) ρ}{2 {τ}_{f}} {A}^{T} A , {W}_{f}^{′} {=}^{△} I - \frac{ρ}{{τ}_{f}} {A}^{T} A , \qquad ( 7 b )$$

According to (6a) and (6b), it can be readily observed that SLAM is amenable to a fully decentralized implementation. The detailed algorithm description is provided in Algorithm 1 from a local view of the model update, where [W]ᵢⱼ denotes the ijth entry of matrix W, [h_{g}^{r}]_{i,k} is the gradient estimate of ∇g_{i,k}(xᵢ^{r}, y_{i,k}^{r}) (i.e., h_{g,k}^{r}=[[h_{g}^{r}]_{1,k}, . . . , [h_{g}^{r}]_{n,k}]^{T}), and similarly [h_{f}^{r}]ᵢ is the local gradient estimate of ∇fᵢ(xᵢ^{r}, y_{i,k}^{r+1}) (i.e., h_{f}^{r}=[[h_{f}^{r}]₁, . . . , [h_{f}^{r}]ₙ]^{T}).

Algorithm 1 Decentralized implementation of SLAM

Initialization: α, β, γ, xᵢ¹, y_{i,k}¹, ∀i, k, and set λ¹ = ωₖ¹ = 0, ∀k ;

| | |
|---|---|
| 1: | for r = 1, 2, ..., T do |
| 2: | for i = 1, 2, ..., n in parallel over the network do |
| 3: | Estimate gradient ∇g_{i,k} (xᵢ^{r}, y_{i,k}^{r}) for each task and ∇fᵢ(xᵢ^{r}, y_{i,k}^{r+1}) locally |
| 4: | y_{i,k}^{r+1} = [symbol] [W_{g}]ᵢⱼy_{j,k}^{r} − [W′_{g}]ᵢⱼy_{j,k}^{r-1} − β⁻¹ ([h_{g}^{r}]_{i,k} − [h_{g}^{r-1}]_{i,k}) [symbol] LL models |
| 5: | xᵢ^{r+1} = [symbol] [W_{f}]ᵢⱼxⱼ^{r} − [W′_{f}]ᵢⱼxⱼ^{r-1} − α⁻¹ ([h_{f}^{r}]ᵢ − [h_{f}^{r-1}]ᵢ) [symbol] UL model |
| 6: | end for |
| 7: | end for |

Besides, if there is a consensus requirement at only one level of the optimization problem, then the problem at the other level becomes one with multiple objective functions. This SLAM can also be applied for solving any of these problems by a minor revision of the generic SLAM formulation. The following discussion is provided to be more specific.

A Special Case of DBO (1) (with only consensus in the LL problems): If there is only a need for consensus of LL model parameters, then problem (2) reduces to the following DBO problem. For example, in solving multi-agent actor-critic RL problems, the UL optimization problem consists of improving the policy for each agent while the LL problem requires all the agents to jointly evaluate the value function over the whole network. The DBO problem is then expressed as

$${min}_{{x}_{i}} {f}_{i} ( {x}_{i} , {y}_{i , k}^{*} ( {x}_{i} ) ) , ∀ i ∈ [ n ] \qquad ( 8 a )$$

$$s . t . {y}_{k}^{*} ( x ) = arg {min}_{{y}_{k}} {g}_{k} ( x , {y}_{k} ) {=}^{△} \frac{1}{n} {\sum }_{i = 1}^{n} {g}_{i , k} ( {x}_{i} , {y}_{i , k} ) s . t . \\ {Ay}_{k} = 0 , ∀ k ∈ [ m ] . \qquad ( 8 b )$$

The major difference between problem (2) and (8) is that the UL optimization problem includes multiple objectives over the model parameters xᵢ, ∀i, ∈[n]. In this case, the updating rule of variable x in (6b) reduces to x^{r+1}=x^{r}−h_{f}^{r}/α by forgoing the dual update w.r.t. λ. The detailed implementation is summarized in Algorithm 2, where the inventors name this special case of SLAM by SLAM-L as the LL consensus process is the main feature in this setting.

### Algorithm 2 Decentralized Iimplementation of SLAM-L

Initialization: α, β, γ, xᵢ¹, y_{i,k}¹, ∀i, k, and set ωₖ¹=0, ∀k;
1: for r=1,2, . . . , T do
2: for i=1,2, . . . , n in parallel over the network do
3: Estimate gradient ∇g_{i,k}(xᵢ^{r}, y_{i,k}^{r}) for each task and ∇fᵢ(xᵢ^{r}, y_{i,k}^{r+1}) locally
4: y_{i,k}^{r+1}= [symbol] [W_{g}]ᵢⱼy_{j,k}^{r}−[W′_{g}]ᵢⱼy_{j,k}^{r-1}−β⁻¹([h_{g}^{r}]_{i,k}−[h_{g}^{r-1}]_{i,k}) [symbol] LL models
5: xᵢ^{r+1}=xᵢ^{r}−α⁻¹[h_{f}^{r}]ᵢ, ∀i [symbol] >UL model
6: end for
7: end for

A Special Case of DBO (1) (with only consensus in the UL problem): The other special is analogous to the first one with the difference being the absence of the LL consensus process in comparison to (2), which is written as follows:

$${min}_{x} f ( x , {y}_{k}^{*} ( x ) {=}^{△} \frac{1}{n} {\sum }_{i = 1}^{n} {f}_{i} ( {x}_{i} , {y}_{i , k}^{*} ( {x}_{i} ) ) \qquad ( 9 a )$$

$$s . t . Ax = 0 , {y}_{i , k}^{*} ( {x}_{i} ) = arg {min}_{{y}_{i , k}} {g}_{i , k} ( {x}_{i} , {y}_{i , k} ) , ∀ i ∈ [ n ] , ∀ k ∈ [ m ] , \qquad ( 9 b )$$

where there are multiple objectives in the LL optimization problems. Problem (9) also covers a wide range of applications in machine learning, e.g., multi-task and/or personalized learning, and so on. In this case, the update of variable yₖ shown in (5a) is changed to yₖ^{r+1}=yₖ^{r}−h_{g}^{r}/β as there is no consensus constraint involved. Analogous to the previous case, the implementation of this algorithm is presented in Algorithm 3 and termed as SLAM-U.

Algorithm 3 Decentralized implementation of SLAM-U

Initialization: α, β, γ, xᵢ¹, y_{i,k}¹, ∀i, k, and set λ¹ = 0, ∀k ;

| | |
|---|---|
| 1: | for r = 1, 2, ..., T do |
| 2: | for i = 1, 2, ..., n in parallel over the network do |
| 3: | Estimate gradient ∇g_{i,k}(xᵢ^{r}, y_{i,k}^{r}) for each task and ∇fᵢ(xᵢ^{r}, y_{i,k}^{r+1}) locally |
| 4: | y_{i,k}^{r+1} = y_{i,k}^{r} − β⁻¹[h_{g}^{r}]_{_{i,k}} [symbol] LL models |
| 5: | xᵢ^{r+1} = [symbol] [W_{f}]ᵢⱼxⱼ^{r} − [W′_{f}]ᵢⱼxⱼ^{r-1} − α⁻¹ ([h_{f}^{r}]ᵢ − [h_{f}^{r-1}]ᵢ) [symbol] UL model |
| 6: | end for |
| 7: | end for |

The following paragraphs provide theoretical convergence results.

Before showing the theoretical results about the convergence guarantees of SLAM, five main classes of assumptions are used in showing the descent of some quantifiable function so that SLAM can reach the E-KKT points of the DBO problems.

Assumptions: The theoretical results are based on the following assumptions on the properties of the loss functions in both the UL and LL optimization problems, which are mainly related to the continuity of the objective function and stochasticity of the gradient estimates.

A1. (Lipschitz continuity of both UL and LL objective functions) Assume that functions fᵢ(⋅), ∇fᵢ(⋅), ∇g_{i,k}(⋅), ∇²gᵢₖ(⋅), ∀i, are (block-wise) Lipschitz continuous with constants L_{f,0}, L_{f,1}, L_{g,1}, L_{g,2} for both x and yₖ, ∀k, and ∇²ₓ_{ᵢ}_{y}_{_{i,k}}g_{i,k}(⋅), ∀i are bounded by C_{xy}.

A2. (Connectivity of graph [symbol] ) The communication graph [symbol] is assumed to be well-connected, i.e., [symbol] L=0 where L=A^{T}A, and the second-smallest eigenvalue of L is assumed to be strictly positive, i.e., \tilde{σ}ₘᵢₙ(A^{T}A)>0.

A3. (Quality of the stochastic gradient estimate) The stochastic estimates of ∇fᵢ(xᵢ, y_{i,k}), ∇yᵢg_{i,k}(xᵢ, y_{i,k}), ∀i, k, are unbiased and their variances are bounded by σ_{f}², σ_{g}².

A4. Assume that the UL objective functions fᵢ(xᵢ, y*i_{,k}(xᵢ)), ∀i, k are lower bounded.

A5. (Strong convexity of g_{i,k}(⋅) w.r.t. y_{i,k}) Function g_{i,k}(⋅) is μ_{g}-strongly convex w.r.t. y_{i,k}, ∀i, k.

Note that these assumptions are commonly used in the convergence analysis for bilevel and decentralized optimization algorithms. Given these assumptions, the following theoretical convergence guarantees can be provided.

### Convergence Rates of SLAM:

Theorem 1. (Convergence rate of SLAM to ϵ-KKT points) Suppose that A1-A5 hold and assume ∥∇_{y}_{ᵢ}_{y}_{ᵢ}²g_{i,k}(⋅, yᵢ)−n⁻¹Σᵢ₌₁ⁿ∇_{y}_{ᵢ}_{y}_{ᵢ}²g_{i,k}(⋅, y′ᵢ)∥≤L_{g}∥yᵢ−y′ᵢ∥, ∀i, k if ∇²g_{i,k}(⋅), ∀i, k are required in computing the UL implicit gradient. When step-sizes are chosen as 1/α˜1/β˜ [symbol] (\sqrt{n/T}), τ_{f}, τ_{g}≥ [symbol] (ρσₘₐₓ(A^{T}A), the mini-batch size of h_{f}^{r} is [symbol] (log(nT), then the iterates {x^{r}, λ^{r}, yₖ^{r}, ωₖ^{r}, ∀k, r} generated by SLAM satisfy

$$UL : \frac{1}{T} {\sum }_{r = 1}^{T} [ {‖ ∇ f ( {\overline{x}}^{r} , {y}_{1}^{*} ( {\overline{x}}^{r} ) , … , \\ {y}_{m}^{*} ( {\overline{x}}^{r} ) ) ‖}^{2} ] \sim \frac{1}{T} {\sum }_{r = 1}^{T} [ {‖ {Ax}^{r} ‖}^{2} ] \sim ( \sqrt{n / T} ) , \qquad ( 10 a )$$

$$LL : \frac{1}{T} {\sum }_{r = 1}^{T} [ {‖ {\overline{y}}_{k}^{r} - {\overline{y}}_{k}^{*} ( {x}^{r} ) ‖}^{2} ] \sim \frac{1}{T} {\sum }_{r = 1}^{T} [ {‖ {Ay}_{k}^{r} ‖}^{2} ] \sim ( \sqrt{n / T} ) , ∀ k , \qquad ( 10 b )$$

where x̅=n⁻¹ [symbol] x, and T denotes the total number of iterations.

Remark 1: It is noted in Theorem 1 that the convergence rate achieved by SLAM to find the E-approximate KKT points of (1) (including both the first-order stationarity of the solutions and the violation of constraints) is on the order of 1/(nϵ2). Therefore, it follows that a linear speedup w.r.t. the number of learners can be achieved by SLAM for DBO, matching the classical results of distributed SGD for only single-level general nonconvex problems.

Remark 2: In comparison with existing bilevel algorithms, SLAM is a single timescale algorithm since the learning rates can be chosen as 1/α˜1/β, which is consistent with ALSET.

Remark 3: A major novelty of obtaining these theoretical results relies on the developed variant of the augmented Lagrangian function and subsequently derived recursion of the successive dual variables, which quantify well the consensus errors resulting from both UL and LL optimization processes in terms of primal variables. Note that this is distinct from the existing theoretical analysis of stochastic algorithms, such as distributed SGD, stochastic gradient tracking, stochastic primal-dual algorithms, etc.

Corollary 1. (Convergence rate of SLAM-L to E-KKT points) Suppose that A1-A5 hold and assume ∥∇_{y}_{ᵢ}_{y}_{ᵢ}²g_{i,k}(xᵢ, yᵢ)−∇_{yy}²gₖ(xᵢ, y′ᵢ)∥≤L_{g}∥yᵢ−y′ᵢ∥, ∀i, k if ∇²g_{i,k}(⋅), ∀i, k are required in computing the UL implicit gradient. When step-sizes are chosen as 1/α˜ [symbol] (1/\sqrt{T}), 1/β˜ [symbol] (\sqrt{n/T}), τ_{f}, τ_{g}≥ [symbol] (ρσₘₐₓ(A^{T}A), ρ≥n, the mini-batch size of h_{f}^{r} is [symbol] (log(nT)), the iterates {x^{r}, yₖ^{r}, ωₖ^{r}, ∇k, r} generated by SLAM-L satisfy

UL:

$$\frac{1}{T} {\sum }_{r = 1}^{T} [ {‖ ∇ {f}_{i} ( {x}_{i}^{r} , {y}_{i , 1}^{*} ( {x}_{i}^{r} ) , … , {y}_{i , m}^{*} ( {x}_{i}^{r} ) ‖}^{2} ] , ∀ i \sim ( n / \sqrt{T} ) and LL : ( 10 b ) .$$

Remark 4: Different from Theorem 1, the stationarity of the UL model parameters requires the shrinkage of the gradient size over each individual UL problem as shown in Corollary 1, so there is no speedup on the convergence rate guarantee at UL.

Corollary 2. (Convergence rate of SLAM-U to E-KKT points) Suppose that A1-A5 hold. Given the conditions on 1/α, 1/β, τ_{f}, τ_{g} and the mini-batch size of h_{f}^{r} shown in Theorem 1, the iterates {x^{r}, λ^{r}, yₖ^{r}, ∇k, r} generated by SLAM-U satisfy

$$UL : ( 10 a ) and LL : \frac{1}{T} {\sum }_{r = 1}^{T} [ {‖ {y}_{k}^{r} - {y}_{k}^{*} ( {x}^{r} ) ‖}^{2} ] \sim ( 1 / \sqrt{nT} ) , ∀ k .$$

The following paragraphs provide numeral results.

In this section, the proposed algorithm is evaluated using two MARL environments: 1) the cooperative navigation task, which is built on the OpenAI Gym platform; and 2) the pursuit-evasion game, which is built on the PettingZoo platform.

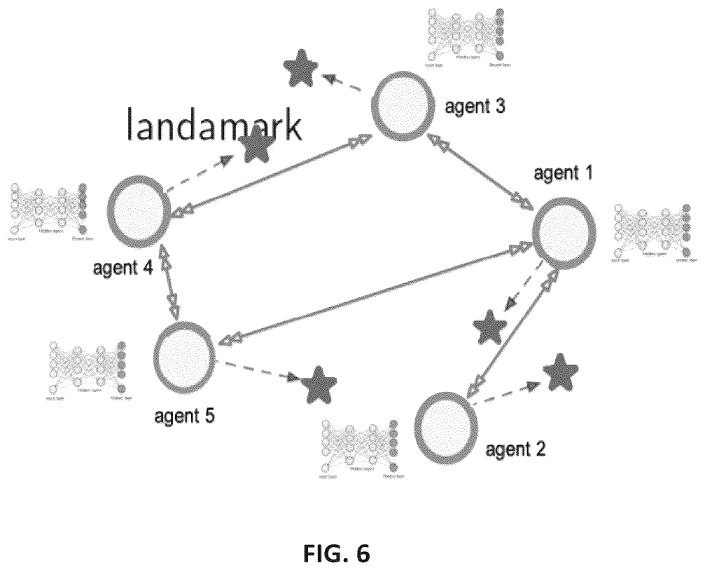

FIG. 6 is a diagram of a bilevel decentralized multi-agent learning system completing a cooperative navigation task, according to certain embodiments of the disclosed technology. In this cooperative navigation task, the n agents are aiming to jointly reach n different landmarks as soon as possible, where the Erdos Renyi Graph is used. It is assumed that each agent can observe the global state and has 5 possible actions: stay, left, right, up, and down. This task consists of a shared common goal of avoiding collision among the agents while they navigate to the targeting landmarks. In the simulations, each agent locally maintains two fully connected neural networks as the actor network (at UL w.r.t. xi) and the critic network (at LL w.r.t. yᵢ), respectively. Moreover, each agent shares its critic network with its neighbors to cooperatively estimate the global value function and independently train its actor network to complete its local task.

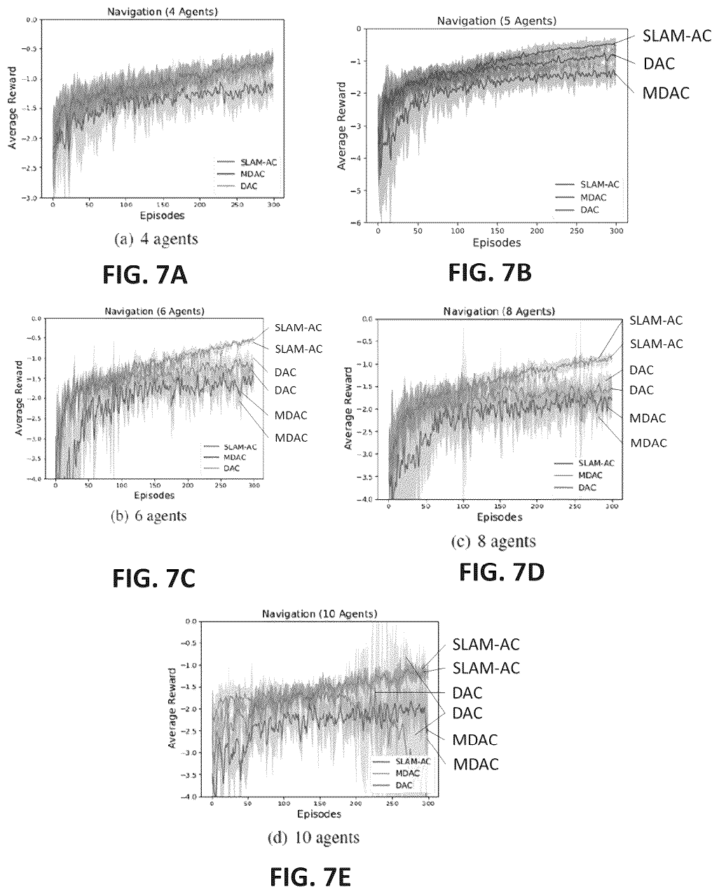

FIGS. 7A-7E are graphs of average reward as a function of episodes during a cooperative navigation task for variations of decentralized learning systems, according to certain embodiments of the disclosed technology. The performance of the SLAM disclosed herein with application to the DAC setting, named SLAM-AC, with two benchmark algorithms: DAC and mini-batch DAC (MDAC) are compared in FIGS. 7A-7E. Theoretically, MDAC needs an [symbol] (ϵ⁻¹ ln ϵ⁻¹) batch size in its inner loop to update critic parameters before each update in policy parameters, which is not practical. Here, a small batch B=10 is set in the inner loop for MDAC to achieve fast convergence. The simulation results on this coordination game are presented in FIGS. 7A-7E, where the performance is averaged over 5 independent Monte Carlo (MC) trials for each algorithm. Note also that in the MDAC and CAC solutions, as the number of agents increases, the noise increases. However, in the SLAM solution, the noise does not increase as the number of agent s increases. This allows for the use of larger number of agents, which can be preferable in reducing the amount of training time.

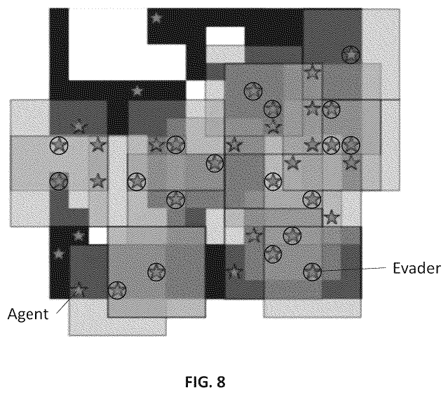

FIG. 8 is a diagram of a cooperative pursuit-evasion task, according to certain embodiments of the disclosed technology. In the pursuit-evasion task, there are two groups of nodes: pursuers (agents, shown as stars) and evaders (shown as circled stars). The agents are connected through a ring graph. Pursuers could observe the global state of the video game. An evader is considered caught if two pursuers simultaneously arrive at the evader's location. As each pursuer should learn to cooperate with other pursuers to catch the evaders, the pursers share certain similarities with each other since they need to follow similar strategies to achieve their local tasks: simultaneously catching an evader with other pursuers.

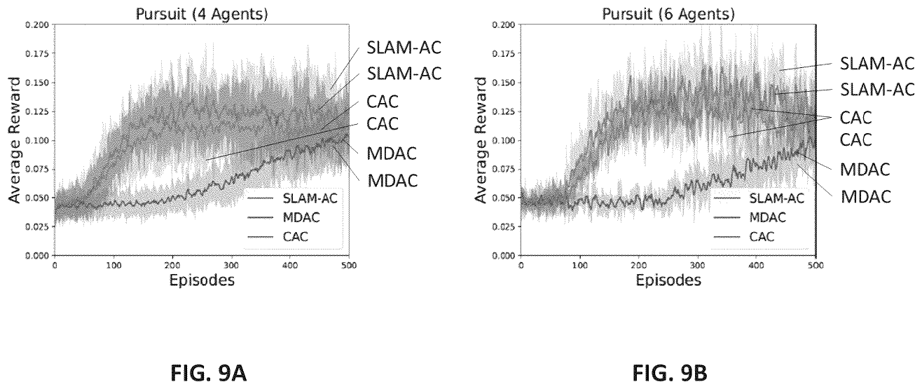

In the experimental setup, all agents partially share their actor networks with neighbors for collaborations in their policy spaces and fully share their critic network to cooperatively learn the global value function. FIGS. 9A and 9B are graphs of average reward as a function of episodes during a cooperative pursuit-evasion task for variations of decentralized learning systems, according to certain embodiments of the disclosed technology. In FIGS. 9A and (b, consensus with one layer of the actor neural nets and all layers of the critic neural nets. In FIGS. 9A and 9B, SLAM-AC is compared with two benchmarks, CAC and MDAC, with 5 MC trials again. To ensure a fair comparison, all algorithms use the same parameter sharing scheme mentioned above. Note that CAC is a variant of DAC and the only difference is that CAC can partially share its policy parameters while the policy parameters are not shared in DAC. In the experiment, each agent maintains two convolutional neural networks, one for the actor and one for the critic.

In this disclosure, a generic form of the DBO problem was studied, which is shown to have three major variants that formulate multiple hierarchical machine learning problems. Targeting these DBO problems, SLAM is proposed-a simple and elegant algorithm to solve DBO in a fully decentralized way. Under mild conditions, theoretical results show that the proposed SLAM is able to find the e-KKT points with a convergence rate of [symbol] (1/(nϵ²)), which matches the standard convergence rate achieved by the classical distributed SGD algorithms for solving only single-level general nonconvex optimization problems. The performance of SLAM was tested numerically on a MARL scenario and found that SLAM outperformed the traditional AC algorithms w.r.t. convergence speed and (in most cases) achievable rewards.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

Aspects of the present technical solutions are described herein with reference to flowchart illustrations and/or block diagrams of methods, apparatuses (systems), and computer program products according to embodiments of the technical solutions. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present technical solutions. In this regard, each block in the flowchart or block diagrams can represent a module, segment, or portion of instructions, which includes one or more executable instructions for implementing the specified logical function(s). In some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A second action can be said to be “in response to” a first action independent of whether the second action results directly or indirectly from the first action. The second action can occur at a substantially later time than the first action and still be in response to the first action. Similarly, the second action can be said to be in response to the first action even if intervening actions take place between the first action and the second action, and even if one or more of the intervening actions directly cause the second action to be performed. For example, a second action can be in response to a first action if the first action sets a flag and a third action later initiates the second action whenever the flag is set.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, ct cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

We claim:

1. A computer-implemented method of decentralized multi-agent learning for use in a system having a plurality of intelligent agents including a select intelligent agent and one or more other intelligent agents, each of the plurality of intelligent agent having a personal portion and a shared portion, the computer-implemented method comprising:
iteratively, until each of a personal goal and a network goal are optimized:
determining, by the select intelligent agent, a feedback associated with an action conducted by the select intelligent agent relative to a personal goal and a degree of similarity relative to a shared goal;
adjusting, by the select intelligent agent, a policy based on the feedback to gain a superior feedback from a next action, wherein the policy comprises a personal policy associated with the select intelligent agent's personal portion and a shared policy associated with the select intelligent agent's shared potion;
broadcasting, by the select intelligent agent to at least one of the one or more other intelligent agents, the shared policy;
receiving, by the select intelligent agent, from at least one of the one or more other intelligent agents, the at least one of the one or more other intelligent agents' shared policy;
generating, by the select intelligent agent, a combined policy by combining the personal policy and the at least one of the one or more other intelligent agents' shared policy;
estimating, by the select intelligent agent, using the combined policy, a network value function; and
conducting, by the intelligent agent, the next action in accordance with the combined policy.

2. The computer-implemented method of claim 1, wherein the personal goal is to maximize the feedback of the select intelligent agent, and the shared goal is to maximize the average feedback of the plurality of intelligent agents.

3. The computer-implemented method of claim 1,
wherein the select intelligent agent comprises a neural network comprises one or more of a first layer and a first several layers, and a plurality of remaining layers, and
wherein the shared portion comprises the one or more of a first layer and a first several layers and the personal portion comprises the plurality of remaining layers.

4. The computer-implemented method of claim 1, wherein receiving the at least one of the one or more other intelligent agents' shared policy comprises:
receiving, by the select intelligent agent, a respective shared policy from each of the one or more other intelligent agents.

5. The computer-implemented method of claim 1,
wherein the one or more other intelligent agents comprises one or more neighboring intelligent agents and one or more non-neighboring intelligent agents, and
wherein receiving the at least one of the one or more other intelligent agents' shared policy comprises receiving, by the select intelligent agent, a respective shared policy from each of the neighboring intelligent agents.

6. The computer-implemented method of claim 5, wherein a distinction between the one or more neighboring intelligent agents and the one or more non-neighboring intelligent agents comprises a distance threshold.

7. The computer-implemented method of claim 1, wherein generating the combined policy comprises combining the personal policy and the at least one of the one or more other intelligent agents' shared policy using a convex combination.

8. The computer-implemented method of claim 7, wherein the convex combination is one of uniform weights, Laplacian weights, a maximum degree weight, a Metropolis-Hastings algorithm, a least-mean square consensus weight rule, and a relative degree (-variance) rule.

9. A decentralized multi-agent learning system comprising:
a plurality of intelligent agents, wherein each of the plurality of intelligent agents comprises a personal portion and a shared portion, wherein each respective intelligent agent of the plurality of intelligent agents is configured to, iteratively, until each of a personal goal and a network goal are optimized:
determine a feedback associated with an action conducted by the respective intelligent agent relative to a personal goal and a degree of similarity relative to a shared goal;
adjust a policy based on the feedback to gain a superior feedback from a next action, wherein the policy comprises a personal policy associated with the personal portion and a shared policy associated with the respective intelligent agent's shared potion;
broadcast the shared policy to at least one of one or more other intelligent agents of the plurality of intelligent agents in the decentralized multi-agent learning system;
receive, from at least one of the one or more other intelligent agents of the plurality of intelligent agents, the at least one of the one or more other intelligent agents' shared policy;
generate a combined policy by combining the personal policy and the at least one of the one or more other intelligent agents' shared policy;
estimate a system value function using the combined policy; and
conduct a next action in accordance with the combined policy.

10. The decentralized multi-agent learning system of claim 9, wherein the personal goal is to maximize the feedback of the respective intelligent agent, and the shared goal is to maximize the average feedback of the plurality of intelligent agents.

11. The decentralized multi-agent learning system of claim 9,
wherein the select intelligent agent comprises a neural network comprises one or more of a first layer and a first several layers, and a plurality of remaining layers, and
wherein the shared portion comprises the one or more of a first layer and a first several layers and the personal portion comprises the plurality of remaining layers.

12. The decentralized multi-agent learning system of claim 9,
wherein the one or more other intelligent agents comprises one or more neighboring intelligent agents and one or more of non-neighboring intelligent agents, wherein a distinction between the one or more neighboring intelligent agents and the one or more non-neighboring intelligent agents comprises a distance threshold, and
wherein the receiving the at least one of the one or more other intelligent agents' shared policy comprises receiving, by the respective intelligent agent, a respective shared policy from each of the neighboring intelligent agents.

13. An intelligent agent for use in a decentralized learning system having one or more other intelligent agents; the intelligent agent comprising:
one or more neural networks, each of the one or more neural networks comprising a personal portion and a shared portion, one or more of the one or more neural networks configured to iteratively, until each of a personal goal and a network goal are optimized:
determine a feedback associated with an action conducted by the intelligent agent relative to a personal goal and a degree of similarity relative to a shared goal;
adjust a policy based on the feedback to gain a superior feedback from a next action, wherein the policy comprises a personal policy associated with the personal portion and a shared policy associated with the shared potion;
broadcast the shared policy to at least one of the one or more other intelligent agents in the decentralized learning system;
receive, from at least one of the one or more other intelligent agents in the decentralized learning system, the at least one of the one or more other intelligent agents' shared policy;
generate a combined policy by combining the personal policy and the at least one of the one or more other intelligent agents' shared policy;
estimate a system value function using the combined policy; and
conduct the new action in accordance with the combined policy.

14. The intelligent agent of claim 13, wherein the personal goal is to maximize the feedback of the intelligent agent, and the shared goal is to maximize the average feedback of the one or more other intelligent agents.

15. The intelligent agent of claim 13,
wherein the select intelligent agent comprises a neural network comprises one or more of a first layer and a first several layers, and a plurality of remaining layers, and
wherein the shared portion comprises the one or more of a first layer and a first several layers and the personal portion comprises the plurality of remaining layers.

16. The intelligent agent of claim 13,
wherein the intelligent agent comprises an actor network and a critic network,
wherein the personal portion comprises one or more of the actor network, the critic network, and both the actor network and the critic network.

17. The intelligent agent claim 13, wherein the receiving the at least one of the one or more other intelligent agents' shared policy comprises:
receiving, by the intelligent agent, a respective shared policy from each of the one or more other intelligent agents.

18. The intelligent agent of claim 13,
wherein the one or more other intelligent agents comprises one or more neighboring intelligent agents and one or more of non-neighboring intelligent agents, and
wherein the receiving the at least one of the one or more other intelligent agents' shared policy comprises receiving, by the intelligent agent, a respective shared policy from each of the neighboring intelligent agents.

19. The intelligent agent of claim 18, wherein a distinction between the one or more neighboring intelligent agents and the one or more non-neighboring intelligent agents comprises a distance threshold.

20. The intelligent agent of claim 13, wherein the generating the combined policy comprises combining the personal policy and the at least one of the one or more other intelligent agents' shared policy using a convex combination.
